(19) United States
(12) Patent Application Publication
(10) Pub. No.: US 2004/0024838 A1
(43) Pub. Date: Feb. 5, 2004

(54) Intelligent data tunnels multiplexed within communications media directly interconnecting two or more multi-logical-unit-mass-storage devices

(76) Inventor: Robert A. Cochran, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/209,987

(22) Filed: Jul. 31, 2002

(51) Int. Cl. G06F 15/167

(52) U.S. Cl. 709/214

(57) ABSTRACT

Method and system for providing intelligent data tunnels for data transfer between users of a distributed system. Intelligent data tunnels are user-to-user communications pathways multiplexed over communications media that directly link mass-storage devices and that are presently used exclusively for transmitting duplicate WRITE requests, and other data-state altering commands, from a first mass-storage device containing a dominant LUN to a second mass-storage device containing a remote-mirror LUN corresponding to the dominant LUN. Intelligent data tunnels make use of spare bandwidth within the direct communications media interconnecting the mass-storage devices to provide an inexpensive data-transfer pathway between users as well as providing an additional communications pathway for the purposes of high-availability and fault-tolerance.

### TECHNICAL FIELD

The present invention relates to electronic communications within distributed systems and, in particular, to a method and system for employing spare bandwidth in a communications medium that directly interconnects mass-storage devices containing primary and remote-mirror logical units in order to provide alternative communications pathways for host computers and remote user computers.

### BACKGROUND OF THE INVENTION

The present invention is related to communications within distributed systems, and, in particular, systems employing two or more large, multi-logical-unit mass-storage devices that are directly interconnected with one or more communications media to facilitate data mirroring. Such systems are frequently used as reliable, fault-tolerant and disaster-tolerant data storage systems in large organizations. An embodiment of the present invention, discussed below, involves disk-array mass-storage devices. To facilitate that discussion, a general description of disk drives and disk arrays is first provided.

The most commonly used, non-volatile mass-storage device in the computer industry is the magnetic disk drive. In the magnetic disk drive, data is stored in tiny magnetized regions within an iron-oxide coating on the surface of the disk platter. A modern disk drive comprises a number of platters horizontally stacked within an enclosure. The data within a disk drive is hierarchically organized within various logical units of data. The surface of a disk platter is logically divided into tiny, annular tracks nested one within another. FIG. 1A illustrated tracks on the surface of a disk platter. Note that, although only a few tracks are shown in FIG. 1A, such as track 101, an actual disk platter may contain many thousands of tracks. Each track is divided into radial sectors. FIG. 1B illustrates sectors within a single track on the surface of the disk platter. Again, a given disk track on an actual magnetic disk platter may contain many tens or hundreds of sectors. Each sector generally contains a fixed number of bytes. The number of bytes within a sector is generally operating-system, dependent, and normally ranges from 512 bytes per sector to 4096 bytes per sector. The data normally retrieved from, and stored to, a hard disk drive is in units of sectors.

The modem disk drive generally contains a number of magnetic disk platters aligned in parallel along a spindle passed through the center of each platter. FIG. 2 illustrates a number of stacked disk platters aligned within a modem magnetic disk drive. In general, both surfaces of each platter are employed for data storage. The magnetic disk drive generally contains a comb-like array with mechanical READ/WRITE heads 201 that can be moved along a radial line from the outer edge of the disk platters toward the spindle of the disk platters. Each discrete position along the radial line defines a set of tracks on both surfaces of each disk platter. The set of tracks within which ganged READ/WRITE heads are positioned at some point along the radial line is referred to as a cylinder. In FIG. 2, the tracks 202-210 beneath the READ/WRITE heads together comprise a cylinder, which is graphically represented in FIG. 2 by the dashed-out lines of a cylinder 212.

FIG. 3 is a block diagram of a standard disk drive. The disk drive 301 receives input/output (“I/O”) requests from remote computers via a communications medium 302 such as a computer bus, fibre channel, or other such electronic communications medium. For many types of storage devices, including the disk drive 301 illustrated in FIG. 3, the vast majority of I/O requests are either READ or WRITE requests. A READ request requests that the storage device return to the requesting remote computer some requested amount of electronic data stored within the storage device. A WRITE request requests that the storage device store electronic data furnished by the remote computer within the storage device. Thus, as a result of a READ operation carried out by the storage device, data is returned via communications medium 302 to a remote computer, and as a result of a WRITE operation, data is received from a remote computer by the storage device via communications medium 302 and stored within the storage device.

The disk drive storage device illustrated in FIG. 3 includes controller hardware and logic 303 including electronic memory, one or more processors or processing circuits, and controller firmware, and also includes a number of disk platters 304 coated with a magnetic medium for storing electronic data. The disk drive contains many other components not shown in FIG. 3, including READ/WRITE heads, a high-speed electronic motor, a drive shaft, and other electronic, mechanical, and electromechanical components. The memory within the disk drive includes a request/reply buffer 305, which stores I/O requests received from remote computers, and an I/O queue 306 that stores internal I/O commands corresponding to the I/O requests stored within the request/reply buffer 305. Communication between remote computers and the disk drive, translation of I/O requests into internal I/O commands, and management of the P/O queue, among other things, are carried out by the disk drive I/O controller as specified by disk drive I/O controller firmware 307. Translation of internal I/O commands into electromechanical disk operations in which data is stored onto, or retrieved from, the disk platters 304 is carried out by the disk drive I/O controller as specified by disk media read/write management firmware 308. Thus, the disk drive I/O control firmware 307 and the disk media read/write management firmware 308, along with the processors and memory that enable execution of the firmware, compose the disk drive controller.

Individual disk drives, such as the disk drive illustrated in FIG. 3, are normally connected to, and used by, a single remote computer, although it has been common to provide dual-ported disk drives for concurrent use by two computers and multi-host-accessible disk drives that can be accessed by numerous remote computers via a communications medium such as a fibre channel. However, the amount of electronic data that can be stored in a single disk drive is limited. In order to provide much larger-capacity electronic data-storage devices that can be efficiently accessed by numerous remote computers, disk manufacturers commonly combine many different individual disk drives, such as the disk drive illustrated in FIG. 3, into a disk array device, increasing both the storage capacity as well as increasing the capacity for parallel I/O request servicing by concurrent operation of the multiple disk drives contained within the disk array.

FIG. 4 is a simple block diagram of a disk array. The disk array 402 includes a number of disk drive devices 403, 404, and 405. In FIG. 4, for simplicity of illustration, only three individual disk drives are shown within the disk array, but disk arrays may contain many tens or hundreds of individual disk drives. A disk array contains a disk array controller 406 and cache memory 407. Generally, data retrieved from disk drives in response to READ requests may be stored within the cache memory 407 so that subsequent requests for the same data can be more quickly satisfied by reading the data from the quickly accessible cache memory rather than from the much slower electromechanical disk drives. Various elaborate mechanisms are employed to maintain, within the cache memory 407, data that has the greatest chance of being subsequently re-requested within a reasonable amount of time. The disk WRITE requests, in cache memory 407, in the event that the data may be subsequently requested via READ requests or in order to defer slower writing of the data to physical storage medium.

Electronic data is stored within a disk array at specific addressable locations. Because a disk array may contain many different individual disk drives, the address space represented by a disk array is immense, generally many thousands of gigabytes. The overall address space is normally partitioned among a number of abstract data storage resources called logical units (“LUNs”). A LUN includes a defined amount of electronic data storage space, mapped to the data storage space of one or more disk drives within the disk array, and may be associated with various logical parameters including access privileges, backup frequencies, and mirror coordination with one or more LUNs. LUNs may also be based on random access memory (“RAM”), mass-storage devices other than hard disks, or combinations of memory, hard disks, and/or other types of mass-storage devices. Remote computers generally access data within a disk array through one of the many abstract LUNs 408-415 provided by the disk array via internal disk drives 403-405 and the disk array controller 406. Thus, a remote computer may specify a particular unit quantity of data, such as a byte, word, or block, using a bus communications media address corresponding to a disk array, a LUN specifier, normally a 64-bit integer, and a 32-bit, 64-bit, or 128-bit data address that specifies a LUN, and a data address within the logical data address partition allocated to the LUN. The disk array controller translates such a data specification into an indication of a particular disk drive within the disk array and a logical data address within the disk drive. A disk drive controller within the disk drive finally translates the logical address to a physical medium address. Normally, electronic data is read and written as one or more blocks of contiguous 32-bit or 64-bit computer words, the exact details of the granularity of access depending on the hardware and firmware capabilities within the disk array and individual disk drives as well as the operating system of the remote computers generating I/O requests and characteristics of the communication medium interconnecting the disk array with the remote computers.

In many computer applications and systems that need to reliably store and retrieve data from a mass-storage device, such as a disk array, a primary data object, such as a file or database, is normally backed up to backup copies of the primary data object on physically discrete mass-storage devices or media so that if, during operation of the application or system, the primary data object becomes corrupted, inaccessible, or is overwritten or deleted, the primary data object can be restored by copying a backup copy of the primary data object from the mass-storage device. Many different techniques and methodologies for maintaining backup copies have been developed. In one well-known technique, a primary data object is mirrored. FIG. 5 illustrates object-level mirroring. In FIG. 5, a primary data object “O₃” 501 is stored on LUN A502. The mirror object, or backup copy, “O₃” 503 is stored on LUN B 504. The arrows in FIG. 5, such as arrow 505, indicate I/O write operations directed to various objects stored on a LUN. I/O write operations directed to object “O₃” are represented by arrow 506. When object-level mirroring is enabled, the disk array controller providing LUNs A and B automatically generates a second I/O write operation from each I/O write operation 506 directed to LUN A, and directs the second generated I/O write operation via path 507, switch “S₁” 508, and path 509 to the mirror object “O₃” 503 stored on LUN B 504. In FIG. 5, ennoblement of mirroring is logically represented by switch “S₁”, 508 being on. Thus, when object-level mirroring is enabled, any I/O write operation, or any other type of I/O operation that changes the representation of object “O₃” 501 on LUN A, is automatically mirrored by the disk array controller to identically change the mirror object “O₃” 503. Mirroring can be disabled, represented in FIG. 5 by switch “S₁” 508 being in an off position. In that case, changes to the primary data object “O₃” 501 are no longer automatically reflected in the mirror object “O₃” 503. Thus, at the point that mirroring is disabled, the stored representation, or state, of the primary data object “O₃” 501 may diverge from the stored representation, or state, of the mirror object “O₃” 503. Once the primary and mirror copies of an object have diverged, the two copies can be brought back to identical representations, or states, by a resync operation represented in FIG. 5 by switch “S₂” 510 being in an on position. In the normal mirroring operation, switch “S₂” 510 is in the off position. During the resync operation, any I/O operations that occurred after mirroring was disabled are logically issued by the disk array controller to the mirror copy of the object via path 511, switch “S₂,” and pass 509. During resync, switch “S₁” is in the off position. Once the resync operation is complete, logical switch “S₂” is disabled and logical switch “S₁” 508 can be turned on in order to reenable mirroring so that subsequent I/O write operations or other I/O operations that change the storage state of primary data object “O₃,” are automatically reflected to the mirror object “O₃” 503.

FIG. 6 illustrates a dominant LUN coupled to a remote-mirror LUN. In FIG. 6, a number of computers and computer servers 601-608 are interconnected by various communications media 610-612 that are themselves interconnected by additional communications media 613-614. In order to provide fault tolerance and high availability for a large data set stored within a dominant LUN on a disk array 616 coupled to server computer 604, the dominant LUN 616 is mirrored to a remote-mirror LUN provided by a remote disk array 618. The two disk arrays are separately interconnected by a dedicated communications medium 620. Note that the disk arrays may be linked to server computers, as with disk arrays 616 and 618, or may be directly linked to communications medium 610. The dominant LUN 616 is the target for READ, WRITE, and other disk requests. All WRITE requests directed to the dominant LUN 616 are transmitted by the dominant LUN 616 to the remote-mirror LUN 618, so that the remote-mirror LUN faithfully mirrors the data stored within the dominant LUN. If the dominant LUN fails, the requests that would have been directed to the dominant LUN can be redirected to the mirror LUN without a perceptible interruption in request servicing. When operation of the dominant LUN 616 is restored, the dominant LUN 616 may become the remote-mirror LUN for the previous remote-mirror LUN 618, which becomes the new dominant LUN, and may be resynchronized to become a faithful copy of the new dominant LUN 618. Alternatively, the restored dominant LUN 616 may be brought up to the same data state as the remote-mirror LUN 618 via data copies from the remote-mirror LUN and then resume operating as the dominant LUN. Various types of dominant-LUN/remote-mirror-LUN pairs have been devised. Some operate entirely synchronously, while others allow for asynchronous operation and reasonably slight discrepancies between the data states of the dominant LUN and mirror LUN.

Owners and operators of large, distributed systems, such as the distributed system described above with reference to FIG. 6, spend very large amounts of money to acquire, rent, or otherwise obtain the services of direct communication links, such as direct communication link 620 in FIG. 6, to enable reliable data mirroring using interconnected mass-storage devices, such as mass-storage devices 616 and 618 in FIG. 6. In addition, owners and users of large distributed systems spend large amounts of money to purchase, or lease, and maintain local area networks, wide area networks, and fibre channels, such as the communications media 610-614 shown in FIG. 6. Despite these large expenses, communications between users accessing the communications media via user computers, such as user computers 601 and 602 in FIG. 6, may at times be error-prone and insufficiently highly available. Owners and operators of large distributed systems have recognized the need for less-expensive and more highly-available user-to-user intercommunications within distributed systems.

### SUMMARY OF THE INVENTION

One embodiment of the present invention provides intelligent data tunnels for data transfer between users of a distributed system. Intelligent data tunnels are user-to-user communications pathways multiplexed over communications media that directly link mass-storage devices and that are presently used exclusively for transmitting duplicate WRITE requests, and other data-state altering commands, from a first mass-storage device containing a dominant LUN to a second mass-storage device containing a remote-mirror LUN corresponding to the dominant LUN. Intelligent data tunnels make use of spare bandwidth within the direct communications media interconnecting the mass-storage devices to provide an inexpensive data-transfer pathway between users as well as providing an additional communications pathway for the purposes of high-availability and fault-tolerance.

### BRIEF DESCRIPTION OF THE DRAWINGS

FIG. 1A illustrates tracks on the surface of a disk platter.

FIG. 1B illustrates sectors within a single track on the surface of the disk platter.

FIG. 2 illustrates a number of disk platters aligned within a modem magnetic disk drive.

FIG. 3 is a block diagram of a standard disk drive.

FIG. 4 is a simple block diagram of a disk array.

FIG. 5 illustrates object-level mirroring.

FIG. 6 illustrates a dominant logical unit coupled to a remote-mirror logical unit.

FIG. 7 shows an abstract representation of the communications-link topography currently employed for interconnecting mass-storage devices containing the dominant and remote-mirror logical units of a mirrored-logical-unit pair.

FIGS. 8A-E illustrates current communications pathways within the communications topology of distributed system illustrated in FIG. 7.

FIG. 9 illustrates one embodiment of the present invention.

FIG. 10 is high-level block diagram of components within a mass-storage device employed, in one embodiment, for implementing intelligent data tunnels.

FIGS. 11A-B illustrates data transfer and data reception through an IDT by the various components within a mass-storage device.

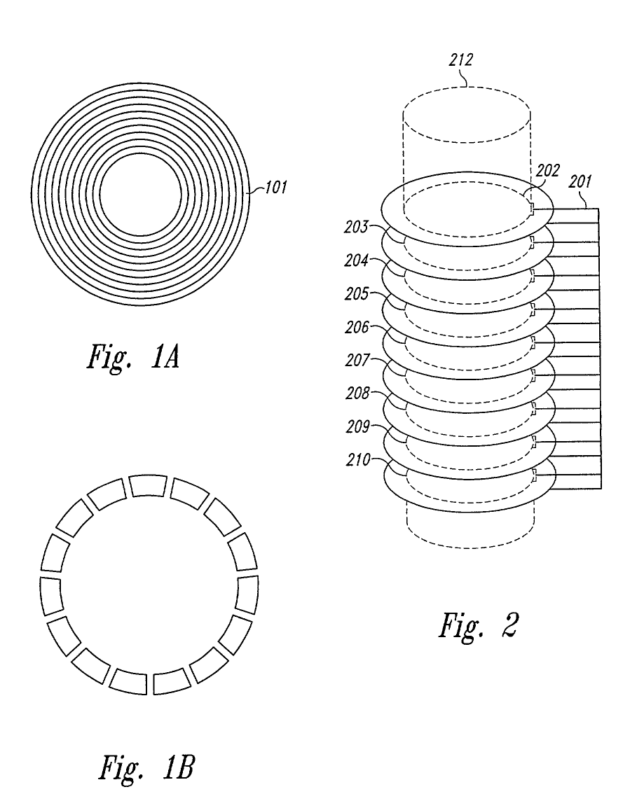

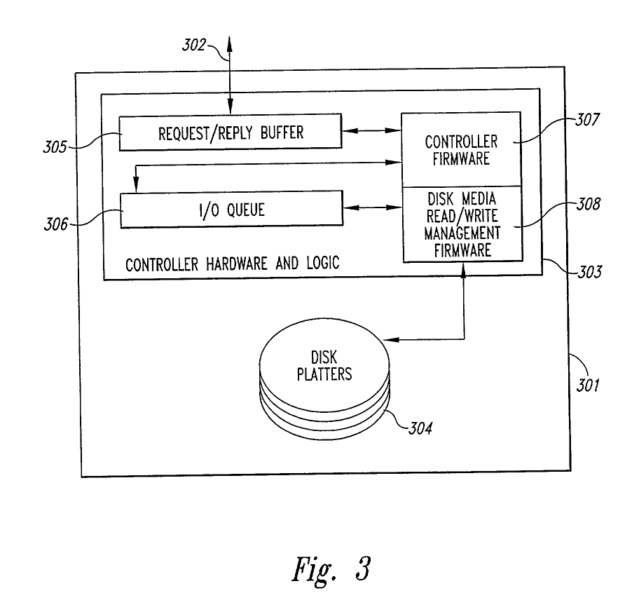

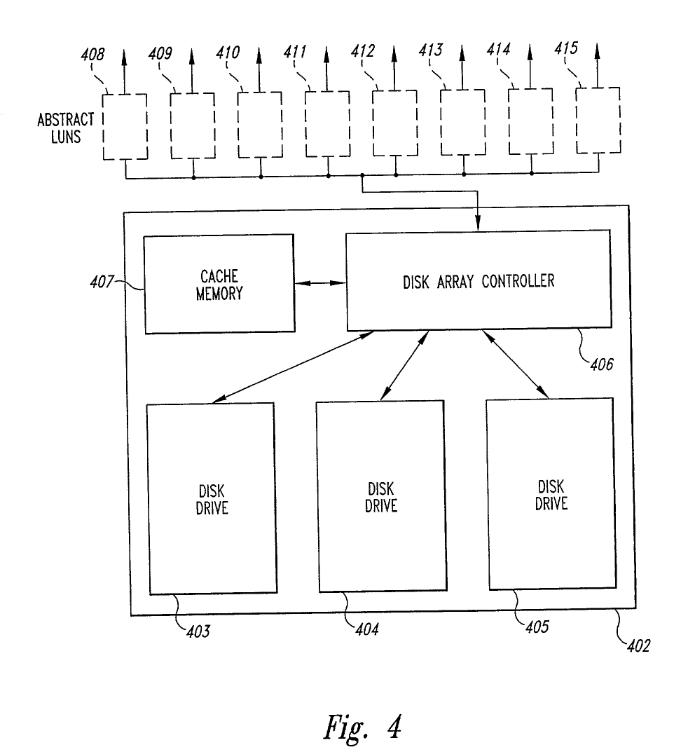

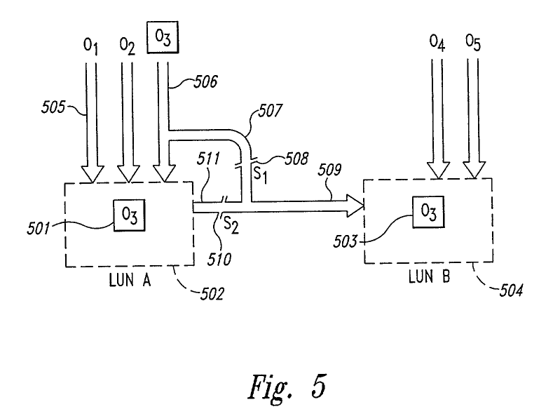

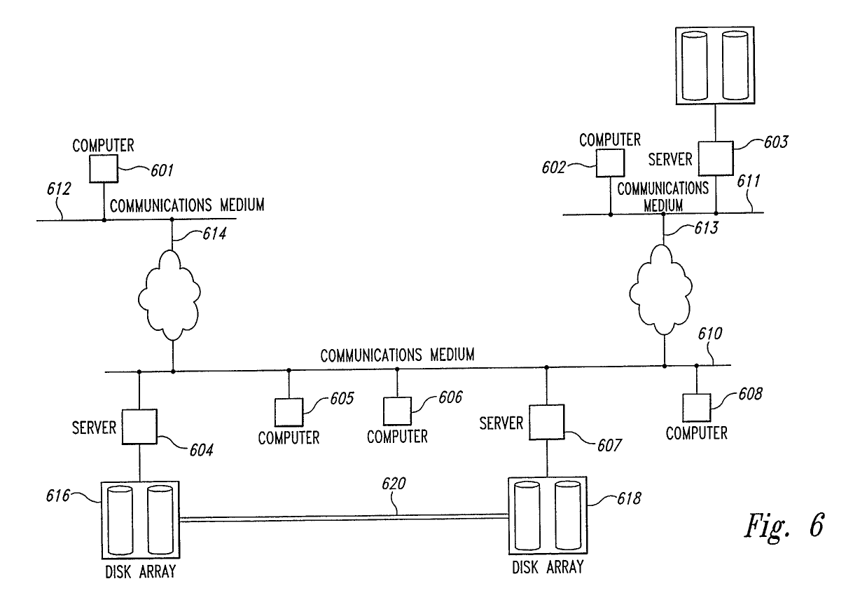

### DETAILED DESCRIPTION OF THE INVENTION

One embodiment of the present invention provides intelligent data tunnels (“IDTs”) for facilitating data transfer and communications between users and host computers within a large distributed system. IDTs are user-to-user, user-to-host, host-to-user, or host-computer-to-host-computer communications links multiplexed over the communications media that directly interconnect mass-storage devices within a distributed system. IDTs may transfer messages in one direction, in two-directions, or in a one-to-many broadcast fashion. Many different types of interfaces and communications capabilities can be implemented on top of IDTs.

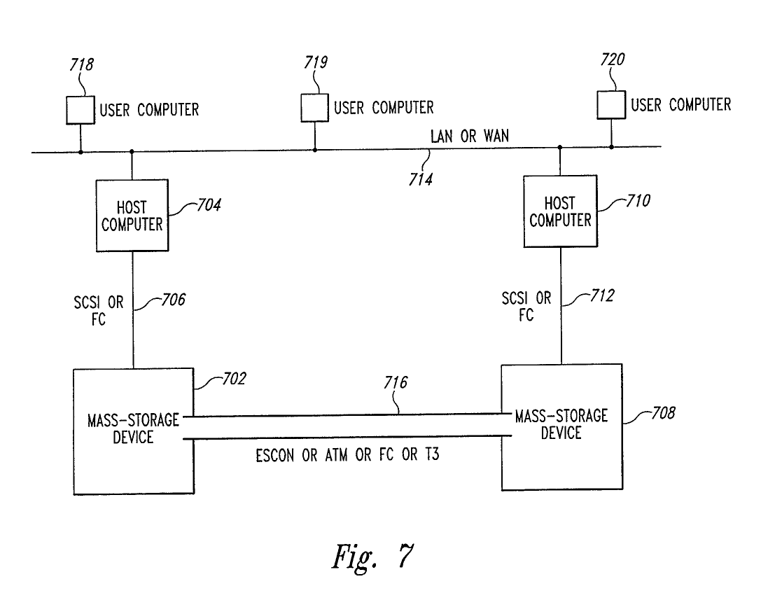

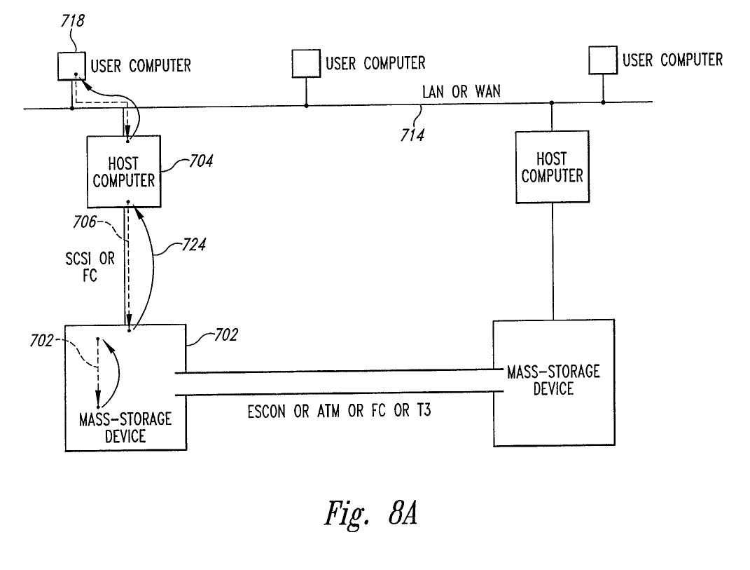

FIG. 7 shows an abstract representation of the communications-link topography currently employed for interconnecting mass-storage devices containing the dominant and remote-mirror LUNs of a mirrored-LUN pair. A first mass-storage device 702 is interconnected with a first host computer 704 via a small-computer-systems interface (“SCSI”), fiber-channel (“FC”), or other type of communications link 706. A second mass-storage device 708 is interconnected with a second host computer 710 via a second SCSI, FC, or other type of communications link 712. The two host computers are interconnected via a local-area network (“LAN”) or wide-area network (“WAN”) 714. The two mass-storage devices 702 and 708 are directly interconnected, for purposes of mirroring, by one or more dedicated enterprise systems connection (“ESCON”), asynchronous transfer mode (“ATM”), FC, T3, or other types of communications links 716. The first mass-storage device 702 contains a dominant LUN of a mirrored-LUN pair, while the second mass-storage device 708 contains the remote-mirror LUN of the mirrored-LUN pair. User computers 718-720 are interconnected with one another and with host computers 704 and 710 via the LAN/WAN 714.

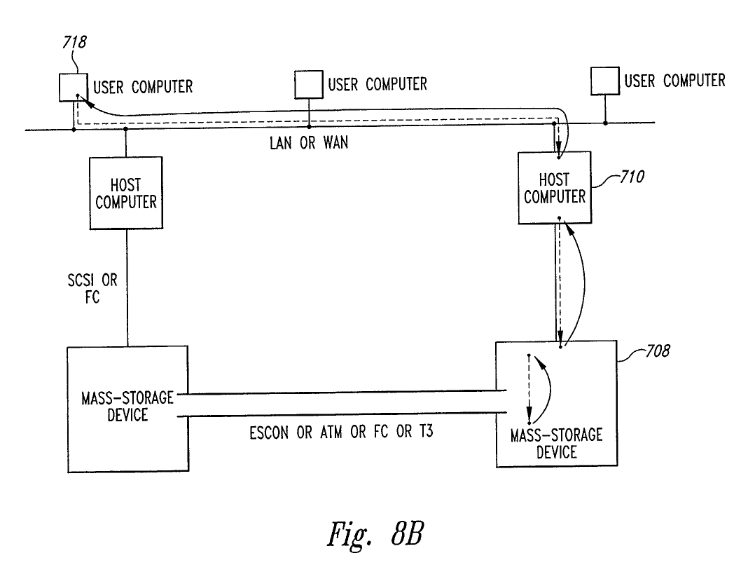

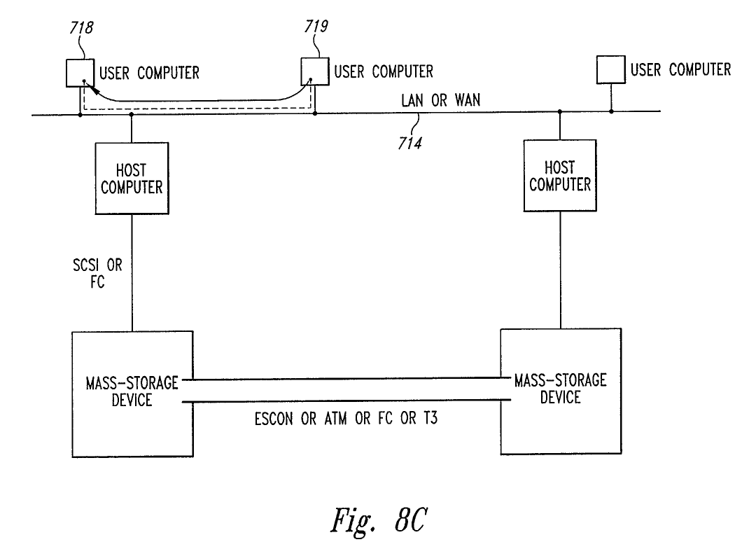

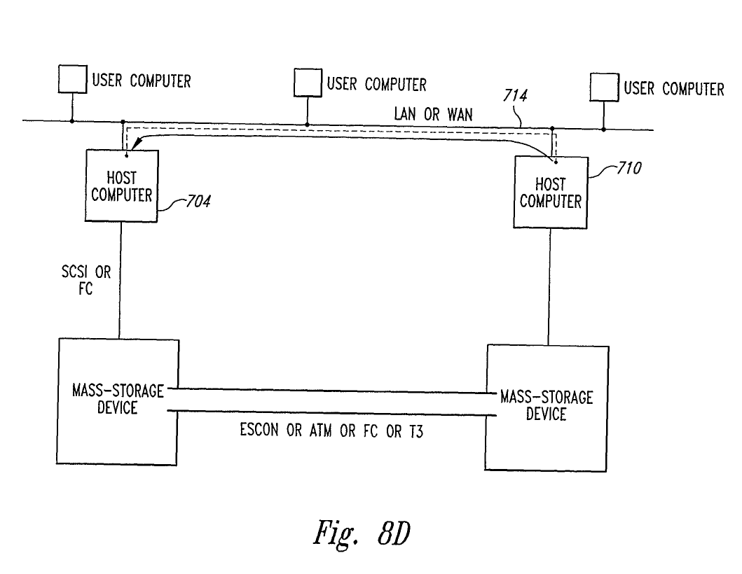

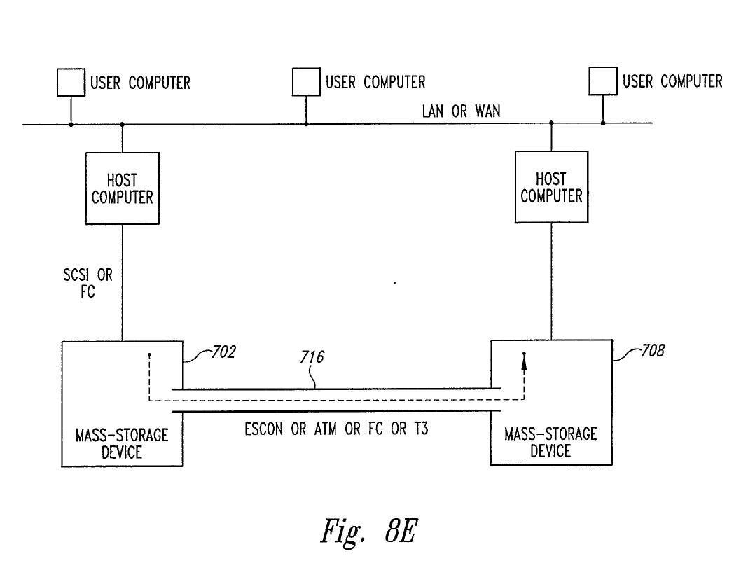

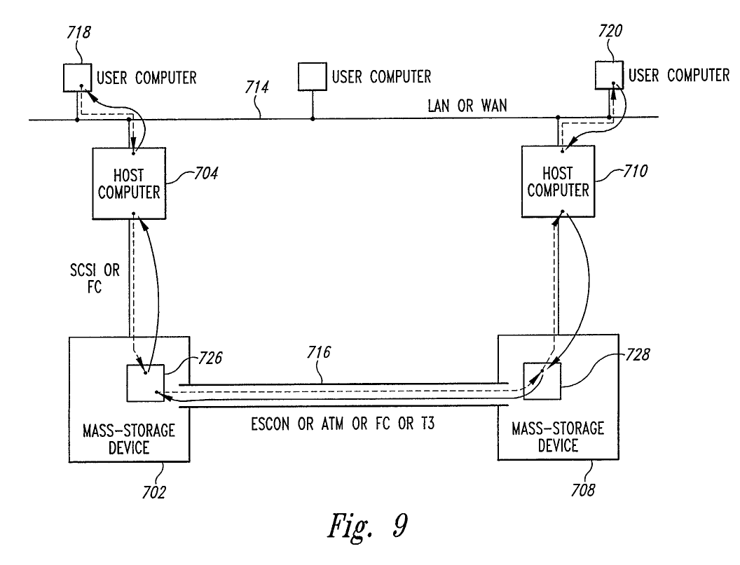

FIGS. 8A-E illustrates current communications pathways within the communications topology of the distributed system illustrated in FIG. 7. FIGS. 8A-E, and FIG. 9 that follows, employ the same illustration conventions as employed in FIG. 7, as well as many of the same numeric labels.

FIG. 8A shows the communications paths within the communication topology of a distributed system that are employed by the distributed system for data exchange between a user and a high-end mass-storage device. As shown in FIG. 8A, a user-computer 718 may issue READ and WRITE commands to, or otherwise access, update, or delete data stored on, the mass-storage device 702 by issuing commands via the LAN/WAN 714 to the host computer 704 coordinating user access to the mass-storage device 702. The host computer then forwards the request to the mass-storage device via the SCSI, FC, or other type of communications link 706. Internally, the mass-storage device executes the request by translating the request, if necessary, and transmitting the request through internal communications media, such as internal SCSI buses 722, to the physical data-storage devices within the mass-storage device. Data and acknowledgement messages are returned by the same communications links in an opposite direction, indicated in FIG. 8A by solid, reverse direction arrows, such as arrow 724.

FIG. 8B shows the communications paths employed by the distributed system to facilitate user access to a remote-mirror LUN on a second mass-storage device following fail-over from a dominant LUN on a first mass-storage device. In FIG. 8B, the user-computer 718 transmits READ and WRITE commands, and other requests and commands to a second host computer 710 that coordinates access to the mass-storage device 708 containing the remote-mirror LUN. The communications paths used to access the remote-mirror LUN following fail-over, shown in FIG. 8B, essentially mirror those used to access the dominant LUN, shown in FIG. 8A.

In the distributed system introduced with reference to FIG. 7, one user computer 718 may directly communicate with another user computer 719 via the LAN/WAN 714, as shown in FIG. 8C. Similarly, a first host computer 704 may communicate with a second host computer 710 via the LAN/WAN 714, as shown in FIG. 8D. Finally, as shown in FIG. 8E, one mass-storage device 702 may directly communication with a second mass-storage device 708 containing a remote-mirror LUN actively mirroring a dominant LUN on the first mass-storage device 702 via the one or more dedicated ESCON, ATM, FC, T3, or other type of links 716. In current systems, the dedicated ESCON, ATM, FC, T3, or other type of links 716 are employed solely for the purposes of transmitting duplicate WRITE requests, and other requests and commands, that alter the data state of a remote-mirror LUN.

Currently, should greater bandwidth or greater fault-tolerance be desired for user-to-user communications, or for host-computer-to-host-computer communications within the distributed system, the LAN/WAN communications medium is either upgraded or supplemented with an additional, parallel LAN/WAN communications medium. Such upgrades and additions are extremely expensive and involve many additional, secondary expenses including hardware upgrades of user computers, such as user computers 718-720, additional system administration overhead, and other such expenses.

However, in general, there may be additional, available bandwidth within the ESCON, ATM, FC, T3, or other type of link or links 716 directly interconnecting mass-storage devices. Note that currently, distributed-system owners may spend hundreds of thousands of dollars per month leasing and maintaining such direct communications links between mass-storage devices. These direct communications links are generally implemented quite differently from the LAN/WAN communications medium 714, and are geographically distinct from the LAN/WAN. The expensive, but surplus bandwidth provided by the largely separately implemented and separately controlled pathway within a distributed system together point to the ESCON, ATM, FC, T3, or other type of link or links 716 as being an attractive potential pathway for user-to-user and host-computer-to-host-computer communications.

FIG. 9 illustrates one embodiment of the present invention. As shown in FIG. 9, new controller functionality 726 and 728 is introduced into each of the mass-storage devices 702 and 706. This new controller functionality 726 and 728 permits commands and messages, directed from user computers 718 and 720, via host computers 704 and 710, to mass-storage devices 702 and 708, to be transmitted, in either direction, over the ESCON, ATM, FC, T3, or other type of link or links 716 in order to provide a complete pathway for data transfer from user computer 718 to user computer 720, separate from the currently used LAN/WAN 714.

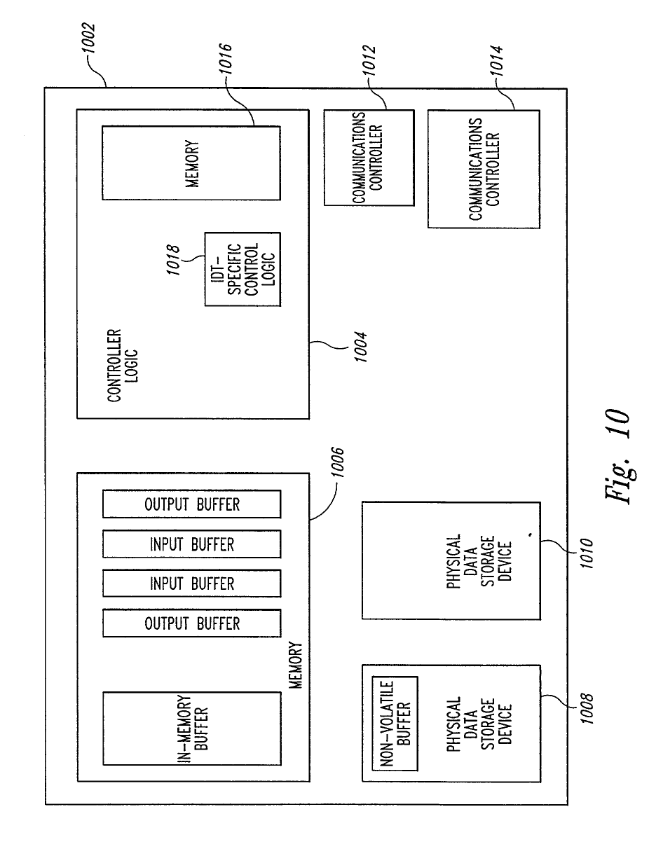

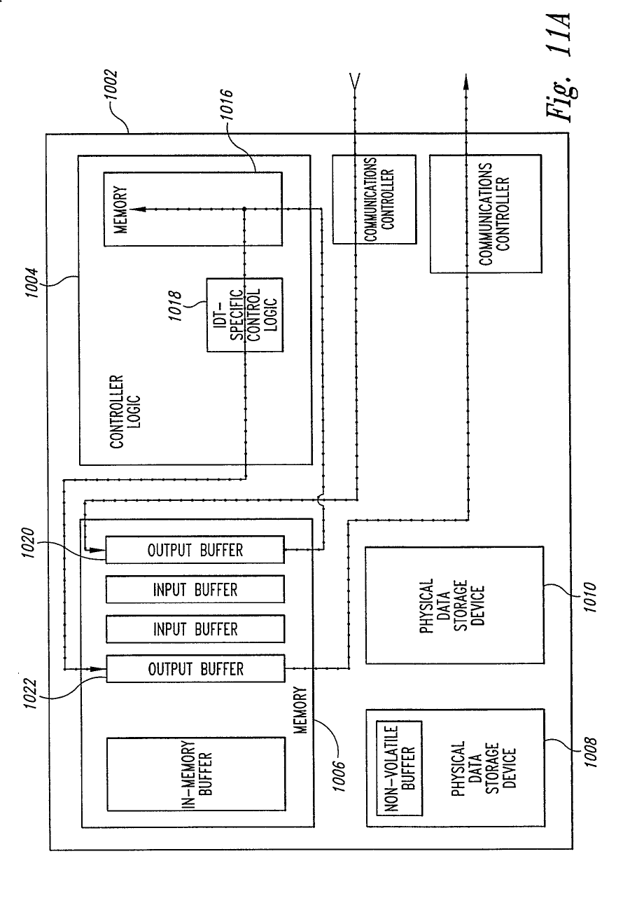

FIG. 10 is high-level block diagram of components within a mass-storage device employed for implementing IDTs. As shown in FIG. 10, the mass-storage device 1002 includes controller logic 1004, implemented in circuits, firmware, or software programs running on a processor, high-speed electronic memory 1006, physical data-storage devices 1008 and 1010, a SCSI, FC, or other type of host-connected controller 1012, and a ESCON, ATM, FC, T3, or other type of remote-mass-storage-device-connected controller 1014. Note that only representative components are shown in FIG. 10. In an actual mass-storage device, many tens or hundreds of physical-data-storage devices and many different communications-link controllers may be present, including additional types communications-link controllers interfaces to types of communications media other ESCON, ATM, FC, T3, or other type of communications links. The controller logic may even be distributed over a number of different processors. FIG. 10 is intended to indicate component types and functional areas needed for implementing IDTs, rather than specific components of a particular embodiment. The controller logic within current mass-storage devices includes one or more logic modules 1016 for interfacing with communications-link controllers and distributing various types of requests and commands to, and receiving various types of requests and commands from, one or more host computers, physical data-storage devices, and one or more remote-storage devices. In order to implement IDTs, the controller logic must be supplemented with new IDT-specific control logic 1018.

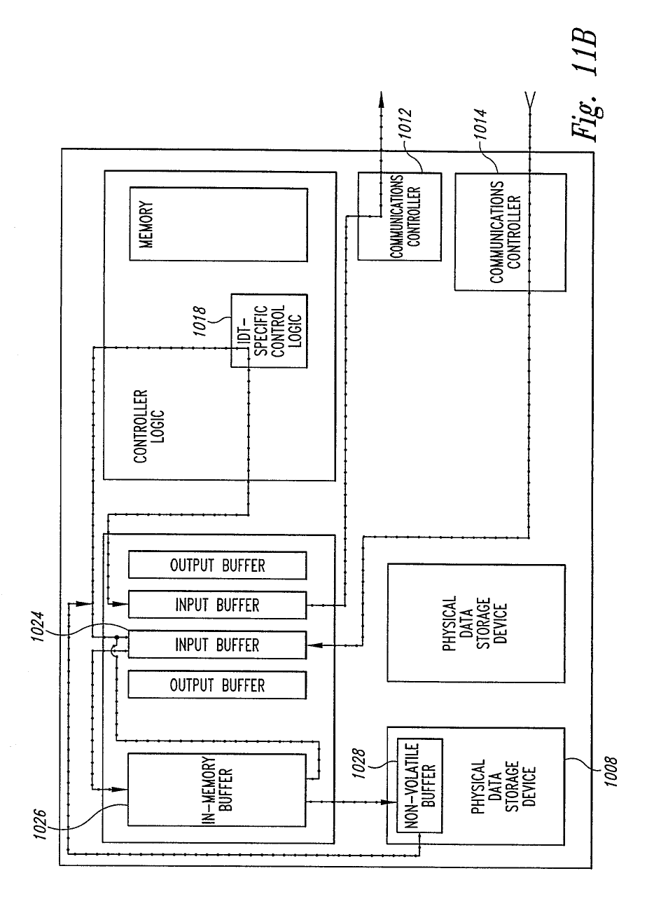

FIGS. 11A-B illustrates data transfer and data reception through an IDT by the various components within a mass-storage device. FIG. 11A illustrates transmission of data received from a host-computer by a mass-storage device 1002 over an IDT to a remote mass-storage device. The data is received from the host-computer via the SCSI, FC, or other type of controller 1012. The data is generally directly transferred by the SCSI, FC, or other type of controller 1012 to an input buffer 1020 within memory 1006. The data is subsequently removed from the input buffer 1020 by control logic 1016 within the controller 1004. The control logic then directs the received data to an appropriate data sink. In order to implement IDTs, the control logic 1016 needs to be changed to recognize a new type of data sink, namely the additional control-logic module 1018 introduced to implement IDTs. The data is passed to the IDT-control logic 1018, which directs the data to an output buffer 1022 in electronic memory 1006. The data is subsequently de-queued from the output buffer 1022 by the ESCON, ATM, FC, T3, or other type of controller 1014 and transmitted to the remote mass-storage device.

FIG. 11B illustrates the components of a mass-storage device involved in receiving data from an IDT. In FIG. 11B, the ESCON, ATM, FC, T3, or other type of I/O controller 1014 receives IDT data from the ESCON, ATM, FC, T3, or other type of link or links, and directs the data to an input buffer 1024 in memory. Under control of the IDT-control logic module 1018, the IDT data may be removed from the input buffer and either stored in a larger, in-memory buffer 1026 or directly output by the IDT-control-logic module 1018 to the SCSI, FC, or other type of controller 1012 for transmission to the host computer. The IDT-controller 1018 may elect to buffer received IDT data in the in-memory buffer 1026 until a recipient user is ready to receive the data and may, additionally, back-up the in-memory buffer 1026 with a non-volatile buffer 1028 on one more of the physical data-storage devices 1008. Although FIGS. 11A-B illustrate an IDT between separate mass-storage devices, IDTs between 2 or more external ports of a single mass-storage device and interlinking of local and remote IDTs are both possible alternative types of IDTs.

There are an almost limitless number of potential applications of IDTs. For example, IDTs may be used as the basis for a simple, LUN-based interface for transferring data from a user-computer via a first host computer and first mass-storage device to a second mass-storage device, from where a second user computer may access the data via a second host computer. In such cases, the user and host-computer interfaces to the mass-storage device need hardly be changed. In more sophisticated applications, host-computer-resident processes may serve as switch-points for point-to-point user-to-user and host-computer-to-host-computer, synchronous and asynchronous connections, bi-directional and uni-directional communications pathways. In these more sophisticated applications, host-computer-resident processes interface to user-computers and establish logical connections to ports or sockets provided by host-computer-resident processes on remote host computers. In still more sophisticated applications, IDT-application support may be extended all the way to background processes running on user computers that interface with host-computer processes that, in turn, interface with control logic within mass-storage devices to send data through mass-storage-to-mass-storage direct communications links. When a mass-storage device is directly interconnected with more than one remote mass-storage device, logical broadcast, or multi-cast, IDTs may be implemented, to transmit the same data to two or more remote mass-storage devices, or to two external ports within the same mass-storage device.

The host-computer-resident processes and mass-storage-device control-logic may cooperate to provide additional functionality, including data-compression, data-encryption, and data-conversion facilities. In addition, sophisticated protocol conversion may be possible. Memory and memory-and-non-volatile-data-storage buffering may allow IDTs to offer store and forward capabilities. IDTs may be used to implement inexpensive remote LUNs, high-speed transfer of video and other multi-media data, email and messaging services, and many other user-level applications. IDTs can, for example, be implemented between external ports of one mass-storage device, between external ports in geographically separated mass-storage devices, or as combinations of single-mass-storage-device and multiple-mass-storage-device IDTs. IDTs configurations can include single IDTs, multiple, parallel IDTs, an end-to-end IDTs. IDTs can, for example, give a host computer the illusion and connection convenience of communicating with two disk LUNs within a locally attached mass-storage device, when one or both LUNs may be remote and/or of a different type and manufacturer than the locally attached LUNs. In such cases, the illusory local LUN may be referred to as a virtual LUN. As another example, a host computer connected to a local mass-storage device may provide a data backup function via the local mass-storage device, with the communications path to the mass-storage device allowing the reading of a disk LUN and writing to a magnetic tape device via IDTs, the physical disk and tape devices located within, or externally attached to, either the local or remote mass-storage device. It should be noted that IDTs, and applications using IDTs, are implementable by many of the various, currently existing communications interface and communication protocol-based technologies.

Although the present invention has been described in terms of a particular embodiment, it is not intended that the invention be limited to this embodiment. Modifications within the spirit of the invention will be apparent to those skilled in the art. For example, any number of additional types of functionalities and user-level services may be implemented on top of IDTs. IDTs may be implemented almost entirely within mass-storage devices, or within additional components of distributed systems, using an almost limitless number of different implementation techniques, modular organizations, and data structures and control logic. Distributed computing services, real-time-communications services, messaging services, data transfer services, remote data storage services, and system management and monitoring services are a few examples of applications that may be built on top of IDTs. IDTs may be implemented in logic circuits, firmware, software, or a combination of logic circuits, firmware, and software.

The foregoing description, for purposes of explanation used specific nomenclature to provide a thorough understanding of the invention. However, it will be apparent to one skilled in the art that the specific details are not required in order to practice the invention. In other instances, well-known portions of disk arrays are shown as diagrams in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments are shown and described in order to best enable others skilled in the art to best utilize the invention and various embodiments with various modifications as are suited to the particular use contemplated. It is intended that the scope of the invention be defined by the following claims and their equivalents:

1. A user-to-user communications pathway within a distributed computing and data storage system comprising:
a first user computer and a second user computer interconnected by a first communications medium;
a first host computer and a second host computer interconnected by the first communications medium, each host computer interconnected to the first and second user computers by the first communications medium;
a first mass-storage device connected to the first host computer via a second communications medium;
a second mass-storage device connected to the second host computer via a third communications medium;
one or more dedicated communications links directly interconnecting the first mass-storage device to the second mass-storage device; and
control logic within the first mass-storage device that transfers data, sent by the first user to the first host computer, and forwarded by the first host computer to the first mass storage device, through the one or more dedicated communications links directly interconnecting the first mass-storage device to the second mass-storage device to the second mass-storage device, that, in turn, transfers the data to the second host computer, which forwards the data to the second user.

2. The user-to-user communications pathway within a distributed computing and data storage system of claim 1 further comprising:
a host-computer-process on the first host computer that serves as a switch-point for collecting messages and data from multiple user computers, and forwards the data and messages through the first mass-storage device and the one or more dedicated communications links directly interconnecting the first mass-storage device to the second mass-storage device and the second mass-storage device to a socket or port provided by a host-computer-process on the second host computer.

3. The user-to-user communications pathway within a distributed computing and data storage system of claim 1 wherein the user-to-user communications pathway transports video and multi-media data.

4. The user-to-user communications pathway within a distributed computing and data storage system of claim 1 used by a user to store and retrieve data from a remote, logical unit.

5. Applications and facilities built on top of the user-to-user communications pathway within a distributed computing and data storage system of claim 1, including:
messaging services;
data transfer services;
remote data storage services;
system management and monitoring services;
distributed computing services; and
real-time-user-to-user communications services.

6. Host-computer-to-host-computer and host-computer-to-user communications pathways for data transfer that are subsets of the user-to-user communications pathway of claim 1.

7. A method for providing a user-to-user communications pathway within a distributed computing and data storage system that includes a first user computer and a second user computer interconnected by a first communications medium, a first host computer and a second host computer interconnected by the first communications medium, each host computer interconnected to the first and second user computers by the first communications medium, a first mass-storage device connected to the first host computer via a second communications medium, a second mass-storage device connected to the second host computer via a third communications medium, and one or more dedicated communications links directly interconnecting the first mass-storage device to the second mass-storage device, the method comprising:
providing control logic within the first and second mass-storage devices that transfers user data from the first mass-storage device to the second mass-storage device through the one or more dedicated communications links directly interconnecting the first mass-storage device to the second mass-storage device to the second mass-storage device;
receiving data sent by the first user via the first communications medium to the first host computer, and forwarded by the first host computer to the first mass storage device via the second communications medium, through the one or more dedicated communications links directly interconnecting the first mass-storage device to the second mass-storage device to the second mass-storage device; and
transferring the data, via the third communications medium, to the second host computer, which forwards the data to the second user via the first communications medium.

8. The method of claim 7 further including:
providing a host-computer-process on the first host computer that serves as a switch-point for collecting messages and data from multiple user computers; and
providing a host-computer-process on the second host computer that a socket or port accessible to the second user computer.

9. The method of claim 7 further including:
building an application or service on top of the user-to-user communications pathway, the application or service selected from among:
a messaging service;
a data transfer service;
a remote data storage service;
a system management and monitoring service;
a distributed computing service; and
a real-time-user-to-user communications service.

10. The method of claim 7 further including transporting video data and multi-media data through the user-to-user communications pathway.

11. A communications pathway within a distributed computing and data storage system comprising:
a first host computer and a second host computer interconnected by a first communications medium;
a first mass-storage device connected to the first host computer via a second communications medium;
a second mass-storage device connected to the second host computer via a third communications medium;
one or more dedicated communications links directly interconnecting the first mass-storage device to the second mass-storage device; and
control logic within the first mass-storage device that transfers data from the first host computer to the second host computer by forwarding the data from the first host computer to the first mass storage device via the second communications medium, through the one or more dedicated communications links directly interconnecting the first mass-storage device to the second mass-storage device to the second mass-storage device, and via the third communications medium to the second host computer.

12. The communications pathway within a distributed computing and data storage system of claim 1 further comprising:
implementing a remote physical LUN on the second mass-storage device accessible to the first host computer via a virtual LUN on the first mass-storage device interfacing to the communications pathway.

13. The communications pathway within a distributed computing and data storage system of claim 12 wherein the remote LUN is of a different type than the virtual LUN.

14. Applications and facilities built on top of the communications pathway within a distributed computing and data storage system of claim 11, including:
messaging services;
data transfer services;
remote data storage services;
system management and monitoring services;
distributed computing services; and
real-time communications services.

15. A method for a communications pathway within a distributed computing and data storage system that includes a first host computer and a second host computer interconnected by a first communications medium, a first mass-storage device connected to the first host computer via a second communications medium, a second mass-storage device connected to the second host computer via a third communications medium, and one or more dedicated communications links directly interconnecting the first mass-storage device to the second mass-storage device, the method comprising:
providing control logic within the first and second mass-storage devices that transfers data from the first mass-storage device to the second mass-storage device through the one or more dedicated communications links directly interconnecting the first mass-storage device to the second mass-storage device to the second mass-storage device;
forwarding data from the first host computer to the first mass storage device via the second communications medium, through the one or more dedicated communications links directly interconnecting the first mass-storage device to the second mass-storage device to the second mass-storage device; and
transferring the data, via the third communications medium, to the second host computer.

16. The method of claim 15 further including:
providing a host-computer-process on the first host computer that serves as a switch-point for collecting messages and data from multiple sources; and
providing a host-computer-process on the second host computer that a socket or port accessible to multiple destinations.

17. The method of claim 15 further including:
building an application or service on top of the communications pathway, the application or service selected from among:
a messaging service;
a data transfer service;
a remote data storage service;
a system management and monitoring service;
a distributed computing service; and
a real-time-user-to-user communications service.

18. The method of claim 15 further including transporting video data and multi-media data through the user-to-user communications pathway.
